(19) United States
(12) Patent Application Publication
(10) Pub. No.: US 2024/0032104 A1
(43) Pub. Date: Jan. 25, 2024

(54) PHYSICAL RANDOM ACCESS CHANNEL (PRACH) ROOT SEQUENCE SELECTION

(71) Applicant: QUALCOMM Incorporated, San Diego, CA (US)

(72) Inventors: Sarath Pinayour Chandrasekaran, Hyderabad (IN); Rekha Devi Bhoopatiraju, Machavaram-Vijayawada (IN); Satish Kumar, Hyderabad (IN)

(21) Appl. No.: 18/252,468

(22) PCT Filed: Jan. 25, 2022
(86) PCT No.: PCT/US2022/070338

§ 371 Date: May 10, 2023

(30) Foreign Application Priority Data
Jan. 29, 2021 (IN) 202141004029

(51) Int. Cl. H04W 74/08; H04L 5/14

(52) U.S. Cl. CPC H04W 74/0833; H04L 5/14

(57) ABSTRACT

In one aspect of the disclosure, a method for wireless communication performed by base station includes receiving a first system information block of type 1 (SIB1) transmitted by a second base station. The transmission of the first SIB1 is based on a first plurality of physical random access channel (PRACH) parameters that are based on one or more first PRACH root sequences associated with the second base station. The method further includes transmitting a second SIB1 based on a second plurality of PRACH parameters that are based on a second PRACH root sequence selected as not to be one of the one or more first PRACH root sequences.

### CROSS-REFERENCE TO RELATED APPLICATIONS

This application claims the benefit of India Pat. App. No. 202141004029 entitled, “PHYSICAL RANDOM ACCESS CHANNEL (PRACH) ROOT SEQUENCE SELECTION,” filed on Jan. 29, 2021, which is expressly incorporated by reference herein in its entirety.

### TECHNICAL FIELD

This disclosure relates generally to wireless communication, and more particularly, to selecting a physical random access channel (PRACH) root sequence for wireless communication with one or more devices, such as one or more user equipments (UEs).

### DESCRIPTION OF THE RELATED TECHNOLOGY

Wireless communication systems are widely deployed to provide various types of communication content such as voice, video, packet data, messaging, broadcast, and so on. A wireless multiple-access communication system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

As the number of wireless devices increases in wireless communications systems, wireless signals may be corrupted by noise and interference. To illustrate, wireless devices may transmit control signals to indicate availability or capabilities of the wireless devices to other devices within range. The other devices may use the control signals to determine whether and how to communicate with the wireless devices. An example of a control signal is a system information block of type 1 (SIB1). A base station may transmit a SIB1 to indicate access parameters associated with the base station, such as physical random access channel (PRACH) parameters associated with the base station. A wireless communication protocol may specify that the base station may select a root sequence and may generate the PRACH parameters based on the root sequence. A UE may receive the SIB1 and may use the access parameters to communicate with the base station. For example, the UE may transmit a PRACH preamble based on the PRACH parameters indicated by the SIB1.

In some cases, wireless signals in a wireless communication system may overlap or contend with one another. As a result, devices may be unable to receive the wireless signals due to collisions between the wireless signals. For example, in some wireless communication protocols, multiple base stations may select a common access parameter, such as a common PRACH parameter. As a result, multiple UEs may concurrently attempt to communicate with the base stations using the common access parameter, potentially resulting in interference and dropped packets. Alternatively or in addition, a device may attempt to communicate with one wireless device while accidentally communicating with another wireless device due to similar parameters associated with the wireless devices (resulting in a false detection). For example, if multiple base stations select a common access parameter, a UE may attempt to communicate with one base station while inadvertently communicating with another base station.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method for wireless communication performed by base station. The method includes receiving a first system information block of type 1 (SIB1) from a second base station and determining, based on the first SIB1, a plurality of physical random access channel (PRACH) parameters associated with the second base station. The method further includes determining, based on the plurality of PRACH parameters, one or more first PRACH root sequences associated with the second base station and determining, based on the one or more first PRACH root sequences, one or more second PRACH root sequences each different than each of the one or more first PRACH root sequences and available to the base station. The method further includes selecting a PRACH root sequence from the one or more second PRACH root sequences and transmitting a second SIB1 based on the selected PRACH root sequence.

Another innovative aspect of the subject matter described in this disclosure can be implemented in a base station. The base station includes at least one processor and a memory coupled with the at least one processor and storing processor-readable code that is executable by the at least one processor to receive a first SIB1 from a second base station and to determine, based on the first SIB1, a plurality of PRACH parameters associated with the second base station. The processor-readable code is further executable by the at least one processor to determine, based on the plurality of PRACH parameters, one or more first PRACH root sequences associated with the second base station and to determine, based on the one or more first PRACH root sequences, one or more second PRACH root sequences each different than each of the one or more first PRACH root sequences and available to the base station. The processor-readable code is further executable by the at least one processor to select a PRACH root sequence from the one or more second PRACH root sequences and to transmit a second SIB1 based on the selected PRACH root sequence.

Another innovative aspect of the subject matter described in this disclosure can be implemented in a base station configured for wireless communication. The base station includes means for receiving a first SIB1 from a second base station and means for determining, based on the first SIB1, a plurality of PRACH parameters associated with the second base station. The base station further includes means for determining, based on the plurality of PRACH parameters, one or more first PRACH root sequences associated with the second base station and means for determining, based on the one or more first PRACH root sequences, one or more second PRACH root sequences each different than each of the one or more first PRACH root sequences and available to the base station. The base station further includes means for selecting a PRACH root sequence from the one or more second PRACH root sequences and means for transmitting a second SIB1 based on the selected PRACH root sequence.

Another innovative aspect of the subject matter described in this disclosure can be implemented in a method for wireless communication performed by a base station. The method includes receiving a first SIB1 transmitted by a second base station. The transmission of the first SIB1 is based on a first plurality of PRACH parameters that are based on one or more first PRACH root sequences associated with the second base station. The method further includes transmitting a second SIB1 based on a second plurality of PRACH parameters. The second plurality of PRACH parameters are based on a second PRACH root sequence selected so as not to be one of the one or more first PRACH root sequences.

Another innovative aspect of the subject matter described in this disclosure can be implemented in a base station that includes at least one processor and a memory coupled with the at least one processor. The memory stores processor-readable code executable by the at least one processor to receive a first SIB1 transmitted by a second base station. The transmission of the first SIB1 is based on a first plurality of PRACH parameters that are based on one or more first PRACH root sequences associated with the second base station. The processor-readable code is further executable by the at least one processor to transmit a second SIB1 based on a second plurality of PRACH parameters. The second plurality of PRACH parameters are based on a second PRACH root sequence selected so as not to be one of the one or more first PRACH root sequences.

Another innovative aspect of the subject matter described in this disclosure can be implemented in a base station for wireless communication. The base station includes means for receiving a first SIB1 transmitted by a second base station. The transmission of the first SIB1 is based on a first plurality of PRACH parameters that are based on one or more first PRACH root sequences associated with the second base station. The apparatus further includes means for transmitting a second SIB1 based on a second on a second PRACH root sequence selected so as not to be one of the one or more first PRACH root sequences.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram of an example wireless communication system that supports physical random access channel (PRACH) root sequence selection according to one or more aspects.

FIG. 4 is a flow diagram illustrating an example process that supports PRACH root sequence selection according to one or more aspects.

FIG. 5 is a flow diagram illustrating an example process that supports PRACH root sequence selection according to one or more aspects.

FIG. 6 is a block diagram of an example base station that supports PRACH root sequence selection according to one or more aspects.

Like reference numbers and designations in the various drawings indicate like elements.

### DETAILED DESCRIPTION

Various aspects of the present disclosure relate generally to parameter selection such that interference between wireless signals transmitted by base stations is reduced or avoided. Some aspects more specifically relate to the selection of a physical random access channel (PRACH) root sequence. In some examples, a base station may receive system information blocks of type 1 (SIB1s) from neighboring base stations. In some examples, the base station may be a small cell base station and one or more of the neighboring base stations may be macro cell base stations. The base station may, based on one or more transmission characteristics of the received SIB1s, reverse engineer one or more PRACH parameters used by the neighboring base stations to transmit the SIB1s. The base station may then identify, based on the determined PRACH parameters, PRACH root sequences in use by the neighboring base stations. Based on the identified PRACH root sequences, the base station may identify one or more other PRACH root sequences that are unused by the neighboring base stations and available to the base station. The base station may then select one of the available PRACH root sequences and transmit a SIB1 based on the selected PRACH root sequence. For example, the base station may generate PRACH parameters based on the selected PRACH root sequence and may indicate the PRACH parameters in the SIB1. One or more user equipments (UEs) may receive the SIB1 and may communicate with the base station based on the PRACH parameters, such as by transmitting a PRACH preamble based on the PRACH parameters.

Particular aspects of the subject matter described in this disclosure can be implemented to realize one or more of the following potential advantages. In some examples, the described techniques can be used to ensure the selection of an unused PRACH root sequence such that a base station may reduce or avoid SIB1 collisions with neighboring base stations that may occur due to use of the same PRACH root sequence. For example, in some wireless communication protocols, by selecting an unused PRACH root sequence, the base station may generate PRACH parameters that are different than PRACH parameters used by neighboring base stations. As a result, UEs that communicate with the base stations may transmit different PRACH preambles based on the different PRACH parameters, thereby reducing or avoiding interference that may be associated with transmission of a common PRACH preamble by the UEs. Further, instances of “false detection” (where a UE attempts to communicate with one base station but inadvertently connects with another base station) may be reduced or avoided by using different PRACH parameters. For example, by selecting an unused PRACH root sequence, a base station may generate PRACH parameters based on the unused PRACH root sequence that are distinct from PRACH parameters associated with neighboring base stations, and a PRACH preamble transmitted by a UE based on the PRACH parameters may be distinct from PRACH preambles associated with the neighboring base stations.

To further illustrate, aspects described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunication system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1M nodes per km\hat{ }2), ultra-low complexity (such as ˜10 s of bits per sec), ultra-low energy (such as ˜10+ years of battery life), and deep coverage with the capability to reach challenging locations; (2) including mission-critical control with strong security to safeguard sensitive personal, financial, or classified information, ultra-high reliability (such as 99.9999% reliability), ultra-low latency (such as ˜1 millisecond (ms)), and users with wide ranges of mobility or lack thereof; and (3) with enhanced mobile broadband including extreme high capacity (such as ˜10 Tbps per km\hat{ }2), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communication systems and applications than the particular examples provided.

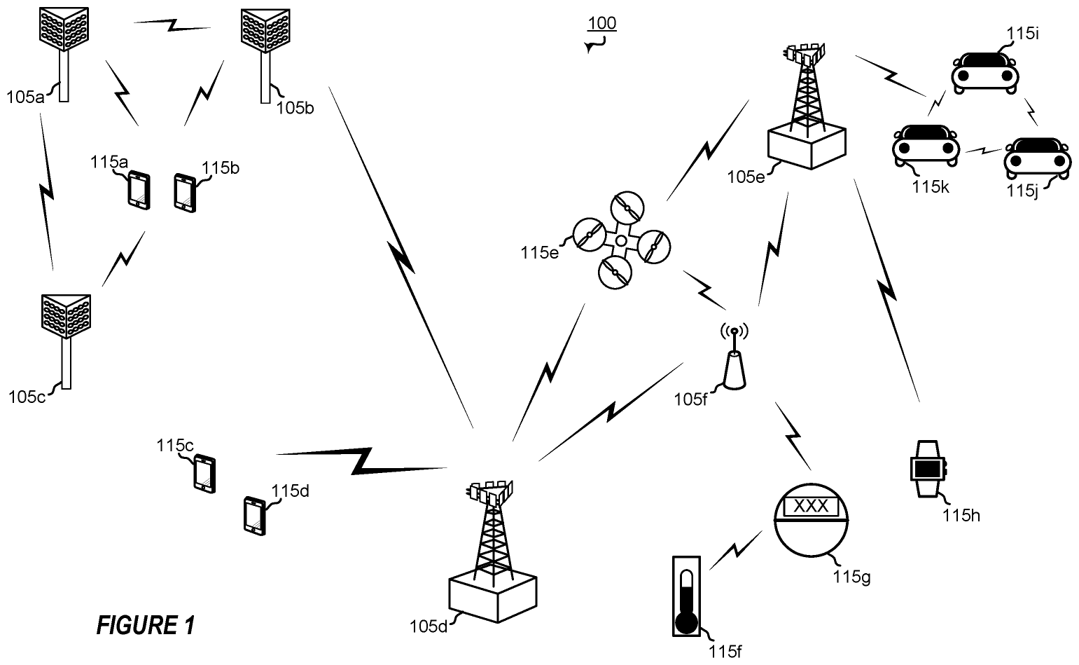

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (CoMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

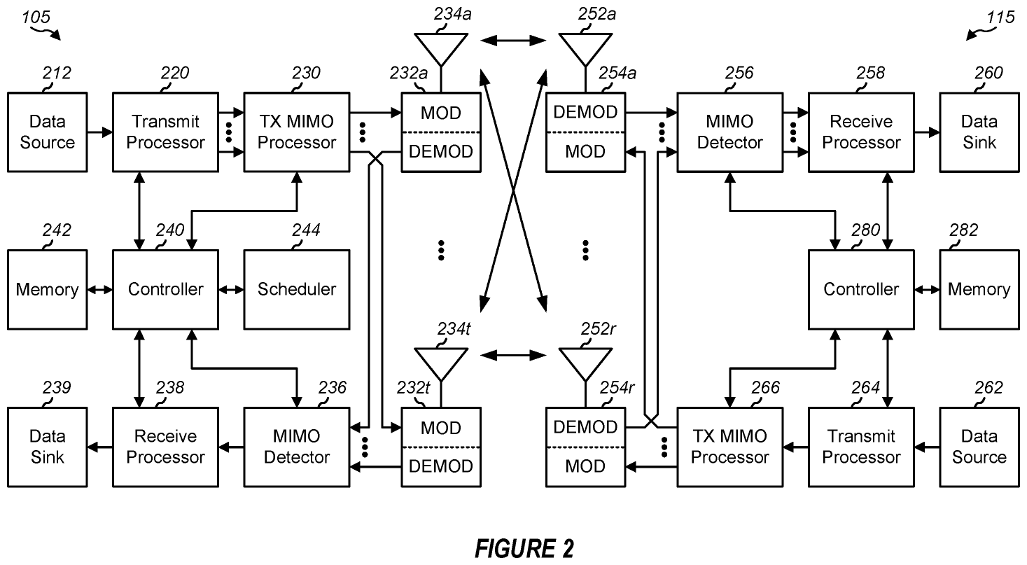

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

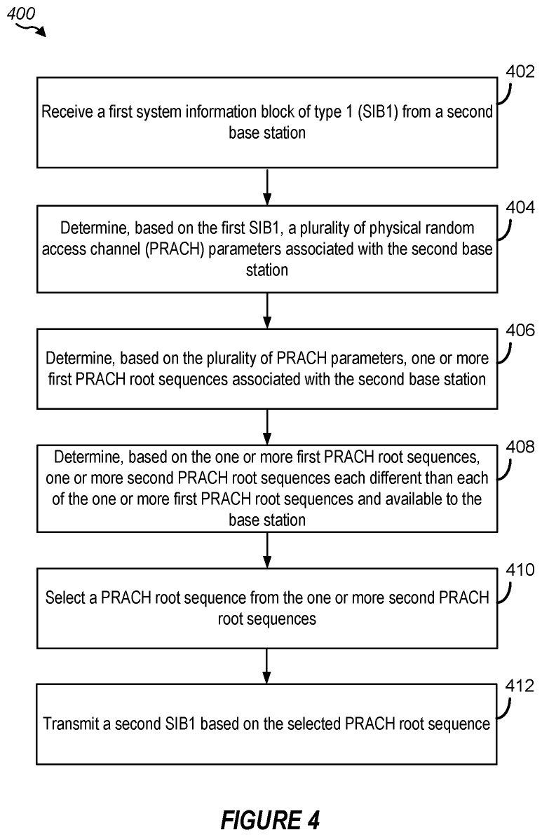

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIG. 4, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

Various aspects of the present disclosure relate generally to parameter selection to reduce or avoid interference between wireless signals transmitted by base stations. Some aspects more specifically relate to selection of PRACH root sequences. In some examples, a base station may receive SIB1s from neighboring base stations. In some examples, the base station may be a small cell base station and one or more of the neighboring base stations may be macro cell base stations. The base station may “reverse engineer” one or more transmission characteristics used by a neighboring base station to transmit a SIB1 received by the base station. For example, the base station may identify, based on the received SIB1, one or more PRACH root sequences in use by the neighboring base station. Based on the identified PRACH root sequences, the base station may identify one or more other PRACH root sequences that are unused by the neighboring base station or otherwise available to the base station. The base station may then select one of the available PRACH root sequences and transmit a SIB1 based on the selected PRACH root sequence. For example, the base station may generate PRACH parameters based on the selected PRACH root sequence and may indicate the PRACH parameters in the SIB1. One or more UEs may receive the SIB1 and may communicate with the base station based on the PRACH parameters, such as by transmitting a PRACH preamble based on the PRACH parameters.

Particular aspects of the subject matter described in this disclosure can be implemented to realize one or more of the following potential advantages. In some examples, the described techniques can be used to ensure the selection of an unused PRACH root sequence such that a base station may reduce or avoid SIB1 collisions with neighboring base stations that may occur due to use of the same PRACH root sequence. For example, in some wireless communication protocols, by selecting an unused PRACH root sequence, the base station may generate PRACH parameters that are different than PRACH parameters used by neighboring base stations. As a result, UEs that communicate with the base stations may transmit different PRACH preambles based on the different PRACH parameters, reducing or avoiding interference that may be associated with transmission of a common PRACH preamble by the UEs. Further, instances of “false detection” (where a UE attempts to communicate with one base station but inadvertently connects with another base station) may be reduced or avoided by using different access parameters associated with the base stations. For example, by selecting an unused PRACH root sequence, a base station may generate PRACH parameters based on the unused PRACH root sequence that are distinct from PRACH parameters associated with neighboring base stations, and a PRACH preamble transmitted by a UE based on the PRACH parameters may be distinct from PRACH preambles associated with the neighboring base stations.

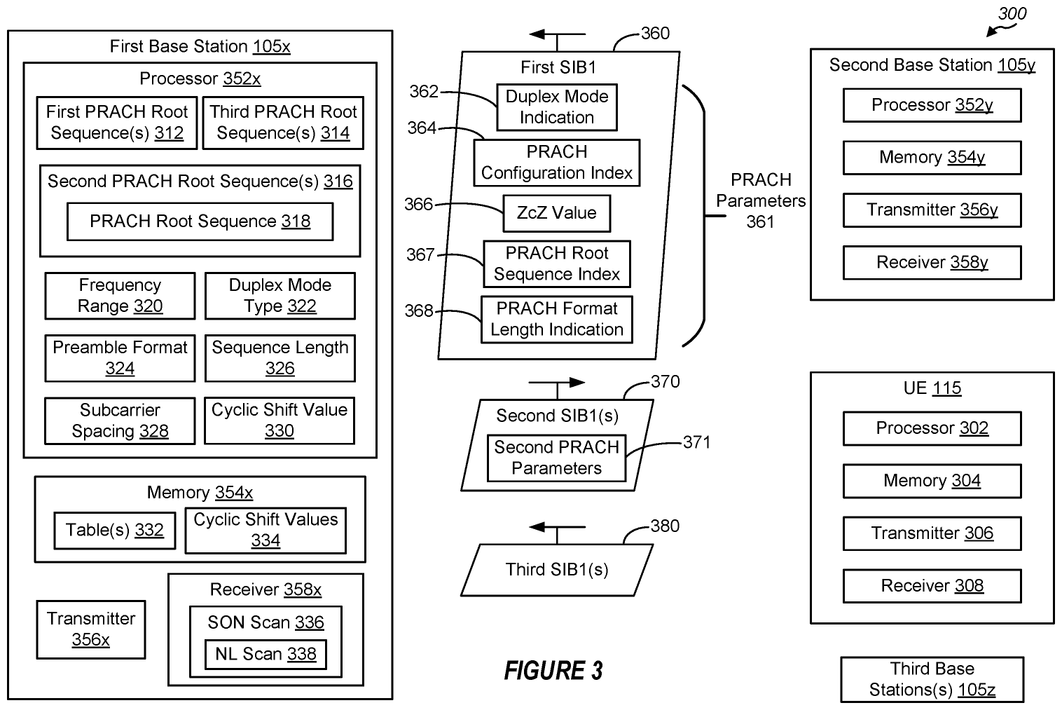

FIG. 3 is a block diagram of an example wireless communication system 300 that supports PRACH root sequence selection according to one or more aspects. In some examples, the wireless communication system 300 may implement aspects of the wireless network 100. The wireless communication system 300 includes one or more base stations, such as a first base station 105x, a second base station 105y, and one or more third base stations 105z. The base stations 105x-z may correspond to any of the base stations described with reference to FIGS. 1 and 2. The wireless communication system 300 may further include one or more UEs, such as the UE 115.

Each base station illustrated in FIG. 3 may include components (such as structural, hardware components) that perform one or more operations described herein. For example, the first base station 105x may include one or more processors 352x (hereinafter referred to collectively as “the processor 352x”), one or more memory devices 354x (hereinafter referred to collectively as “the memory 354x”), one or more transmitters 356x (hereinafter referred to collectively as “the transmitter 356x”), and one or more receivers 358x (hereinafter referred to collectively as “the receiver 358x”). As another example, the second base station 105y may include one or more processors 352y (hereinafter referred to collectively as “the processor 352y”), one or more memory devices 354y (hereinafter referred to collectively as “the memory 354y”), one or more transmitters 356y (hereinafter referred to collectively as “the transmitter 356y”), and one or more receivers 358y (hereinafter referred to collectively as “the receiver 358y”). The processors 352x-y may each be configured to execute instructions stored in the memories 354x-y to perform one or more operations described herein. In some implementations, the processors 352x-y each include or correspond to one or more of the receive processor 238, the transmit processor 220, or the controller 240, and the memories 354x-y each include or correspond to the memory 242.

The transmitters 356x-y may transmit reference signals, synchronization signals, control information, and data to one or more other devices, such as the UE 115. The receivers 358x-y may receive reference signals, control information, and data from one or more other devices, such as the UE 115. For example, the transmitters 356x-y may transmit signaling, control information, and data to the UE 115, and the receivers 358x-y may receive signaling, control information, and data from the UE 115. In some implementations, the transmitter 356x and the receiver 358x may be integrated in one or more transceivers of the first base station 105x, and the transmitter 356y and the receiver 358y may be integrated in one or more transceivers of the second base station 105y. Additionally or alternatively, the transmitters 356x-y and the receivers 358x-y may include or correspond to one or more components of base station 105 described with reference to FIG. 2.

The UE 115 may include components (such as structural, hardware components) that perform one or more operations described herein. For example, such components may include one or more processors 302 (hereinafter referred to collectively as “the processor 302”), one or more memory devices 304 (hereinafter referred to collectively as “the memory 304”), one or more transmitters 306 (hereinafter referred to collectively as “the transmitter 306”), and one or more receivers 308 (hereinafter referred to collectively as “the receiver 308”). The processor 302 may be configured to execute instructions stored in the memory 304 to perform one or more operations described herein. In some implementations, the processor 302 includes or corresponds to one or more of the receive processor 258, the transmit processor 264, or the controller 280, and the memory 304 includes or corresponds to the memory 282.

The transmitter 306 may transmit reference signals, control information, and data to one or more other devices, such as any of the base stations 105x-z. The receiver 308 may receive reference signals, synchronization signals, control information, and data from one or more other devices, such as any of the base stations 105x-z. For example, the transmitter 306 may transmit signaling, control information, and data to the first base station 105x, and the receiver 308 may receive signaling, control information, and data from the first base station 105x. In some implementations, the transmitter 306 and the receiver 308 may be integrated in one or more transceivers. Additionally or alternatively, the transmitter 306 or the receiver 308 may include or correspond to one or more components of the UE 115 described with reference to FIG. 2.

In some implementations, the wireless communication system 300 implements a New Radio (NR) network. For example, the wireless communication system 300 may include multiple 5G-capable UEs 115 and multiple 5G-capable base stations 105, such as UEs and base stations configured to operate in accordance with a 5G NR network protocol such as that defined by the 3 GPP.

In some examples, the first base station 105x corresponds to a small cell base station, and the second base station 105y corresponds to a macro base station. To illustrate, the first base station 105x may correspond to the small cell base station 105f of FIG. 1, and the second base station 105y may correspond to one of the macro base stations 105d-e of FIG. 1.

During operation of the wireless communication system 300, the second base station 105y may transmit a first SIB1 360. The first SIB1 may indicate PRACH parameters 361 associated with the second base station 105y. In some examples, the PRACH parameters 361 may include one or more of a duplex mode indication 362, a PRACH configuration index 364, a zero correlation zone (ZcZ) value 366, a PRACH root sequence index 367, or a PRACH format length indication 368.

The first base station 105x may receive the first SIB1 360. To illustrate, the first base station 105x may perform a scan to receive the first SIB1 360. In a non-limiting illustrative example, the scan may include one or more of a self-organizing network (SON) scan 336 or a network listening (NL) scan 338, and the first base station 105x may receive the first SIB1 360 based on one or more of the SON scan 336 or the NL scan 338. In some examples, the first base station 105x performs the NL scan 338 during or in connection with the SON scan 336. The first base station 105x may perform one or more of the SON scan 336 or the NL scan 338 based on detecting one or more trigger conditions, such as a boot-up operation of the first base station 105x, as an illustrative example. Alternatively or in addition, the first base station 105x may perform one or more of the SON scan 336 or the NL scan 338 based on a scan schedule, such as a periodic scan schedule.

The first base station 105x may determine the PRACH parameters 361 based on the first SIB1 360. For example, the first base station 105x may decode the first SIB1 360 using a modem, decoder, or other device to identify the PRACH parameters 361. To further illustrate, Example 1 depicts pseudocode corresponding to example contents of the first SIB1 360.

### Example 1

```
SIB1 −> ServingCellConfigCommonSIB −> TDD-UL-DL-Config
UplinkConfigCommonSIB −> BWP-UplinkCommon −> RACH-ConfigCommon
  {
  RACH-ConfigGeneric:
    {
    prach-ConfigurationIndex,
    zeroCorrelationZoneConfig
    }
  totalNumberOfRA-Preambles
  prach-RootSequenceIndex:
    {
    Long Format −> L_RA = 839 −> INTEGER (0..837),
    Short Format −> L_RA = 139 −> INTEGER (0..137),
    }
  msg1-SubcarrierSpacing
  restrictedSetConfig
  }
```

In Example 1, TDD-UL-DL-Config may correspond to the duplex mode indication 362, prach-ConfigurationIndex may correspond to the PRACH configuration index 364, zeroCorrelationZoneConfig may correspond to the ZcZ value 366, and prach-RootSequenceIndex may correspond to the PRACH root sequence index 367. In some examples, the PRACH format length indication 368 indicates one of a long format or a short format of the first SIB1 360. The long format may be associated with a first set of candidate PRACH root sequences (such as 838 candidate PRACH root sequences), and the short format may be associated with a second set of candidate PRACH root sequences (such as 138 candidate PRACH root sequences). The PRACH root sequence index 367 may correspond to one of the candidate PRACH root sequences. For example, the PRACH root sequence index 367 may have a value selected from 0, 1, . . . 838 in connection with the long format or may have a value selected from 0, 1, . . . 137 in connection with the short format.

The first base station 105x may determine, based on the PRACH parameters 361, one or more first PRACH root sequences 312 associated with the second base station 105y. To further illustrate, the first base station 105x may perform an example process to determine the one or more first PRACH root sequences 312 based on the PRACH parameters 361. The process may include determining a frequency range 320 associated with the first SIM 360. For example, if the first base station 105x detects that a frequency associated with second base station 105y is less than 6 gigahertz (GHz), the first base station 105x may determine that the frequency range 320 corresponds to a second frequency range (FR2). As another example, if the first base station 105x detects that the frequency associated with second base station 105y greater than or equal to 6 GHz, the first base station 105x may determine that the frequency range 320 corresponds to a first frequency range (FR1).

The process may further include determining, based on the duplex mode indication 362, a duplex mode type 322 associated with the second base station 105y. For example, if the first SIM 360 includes a TDD-UL-DL-Config indication (such as illustrated in Example 1), the first base station 105x may determine that the duplex mode indication 362 corresponds to one or both of a time division duplex (TDD) mode or an unpaired spectrum mode. As another example, if the first SIB1 360 does not include a TDD-UL-DL-Config indication, the first base station 105x may determine that the duplex mode indication 362 corresponds to one or both of a frequency division duplex (FDD) mode or a paired spectrum mode.

The first base station 105x may identify, based on the frequency range 320 and the duplex mode type 322, a PRACH configuration index table, which may be included in one or more tables 332 stored at the memory 354x. In some examples, a wireless communication protocol (such as a 5G NR wireless communication protocol) specifies the one or more tables 332. The first base station 105x may identify, in the PRACH configuration index table based on the PRACH configuration index 364, a preamble format 324 of the first SIM 360 (such as by using the PRACH configuration index 364 as a lookup to the PRACH configuration index table). In some implementations, the one or more tables 332 include or correspond to “transmitter side” tables that are used by one or more base stations to determine transmitter operation (such as by the second base station 105y to determine operation of the transmitter 356y). In some aspects of the disclosure, the first base station 105x may use the one or more tables 332 to “reverse engineer” certain aspects of operation of the transmitter 356y based on the first SIB1 360 to reduce or avoid SIB1 collisions.

The process may further include determining, based on the preamble format 324, a sequence length 326 and a subcarrier spacing 328 that are associated with the first SIB1 360. For example, the first base station 105x may use the preamble format 324 as a lookup to another table included in the one or more tables 332 to determine the sequence length 326 and the subcarrier spacing 328. In some wireless communication protocols, the preamble format 324 may correspond to a parameter L_RA having a value of 839 if the first SIB1 360 has a long format or having a value of 139 if the first SIB1 360 has a short format. To further illustrate, in some wireless communication protocols, if the preamble format 324 has a value of 0, 1, or 2, then the sequence length 326 may have a value of 839, and the subcarrier spacing 328 may have a value of 1.25 kilohertz (KHz). As another example, if the preamble format 324 has a value of 3, then the sequence length 326 may have a value of 839, and the subcarrier spacing 328 may have a value of 5 KHz. As an additional example, if the preamble format 324 has another value, then the sequence length 326 may have a value of 139, and the subcarrier spacing 328 may have a value of 15 KHz.

The process may also include determining a mapping of the ZcZ value 366 to a cyclic shift value 330 based on the subcarrier spacing 328 (such as using a table of the one or more tables 332). The cyclic shift value 330 may be based on the PRACH format length indication 368. In some wireless communication protocols, the cyclic shift value 330 may correspond to a parameter Ncs. To further illustrate, in some wireless communication protocols, if the subcarrier spacing 328 corresponds to 1.25 KHz, 5 KHz, or another value, then the first base station 105x may use a first table, a second table, or a third table, respectively, to determine the mapping of the ZcZ value 366 to the cyclic shift value 330.

The process may further include determining a cardinality (such as a positive integer number) of preambles per PRACH root sequence associated with the second base station 105y based on a ratio of the sequence length 326 to the cyclic shift value 330. The cardinality may indicate the number of PRACH root sequences included in the first PRACH root sequences 312. To further illustrate, Example 2 depicts an example table that may be included in the one or more tables 332.

### Example 2

| | | | | Number of |
|---|---|---|---|---|
| | | Number of | | Unused |
| | Cyclic | Preambles | Number of | Starting |
| ZcZ | Shift | per Root | Roots used | Logical Root |
| Value | Value | (for example, | to generate | Sequence |
| 366 | 330 | L_RA/Ncs) | 64 Preambles | Indices |
| 0 | 0 | 1 | 64 | 11 |
| 1 | 2 | 69 | 1 | 137 |
| 2 | 4 | 34 | 2 | 135 |
| 3 | 6 | 23 | 3 | 133 |
| 4 | 8 | 17 | 4 | 131 |
| 5 | 10 | 13 | 5 | 129 |
| 6 | 12 | 11 | 6 | 127 |
| 7 | 13 | 10 | 7 | 125 |
| 8 | 15 | 9 | 8 | 123 |
| 9 | 17 | 8 | 8 | 123 |
| 10 | 19 | 7 | 10 | 119 |
| 11 | 23 | 6 | 11 | 117 |
| 12 | 27 | 5 | 13 | 113 |
| 13 | 34 | 4 | 16 | 107 |
| 14 | 46 | 3 | 22 | 95 |
| 15 | 69 | 2 | 32 | 75 |

Example 2 illustrates that a ratio of the sequence length 326 to the cyclic shift value 330 (such as illustrated in the third column of Example 2) may be associated with a corresponding number of roots used to generate a particular number of preambles (such as 64 preambles, as illustrated in the fourth column of Example 2) and a number of unused starting logical root sequences (as illustrated in the fifth column of Example 2). A value in the fourth column of Example 2 may correspond to the cardinality of preambles per PRACH root sequence associated with the second base station 105y. Although in Example 2 the sequence length 326 may correspond to 139, other values are also within the scope of the disclosure.

The first base station 105x may determine the one or more first PRACH root sequences 312 based on the cardinality and further based on the PRACH root sequence index 367. For example, a wireless communication protocol may specify a group of candidate PRACH root sequences, and determining the one or more first PRACH root sequences 312 may include selecting, based on the PRACH root sequence index 367 and based further on the cardinality, the one or more first PRACH root sequences 312 from the group of candidate PRACH root sequences specified by the wireless communication protocol.

The first base station 105x may determine, based on the one or more first PRACH root sequences 312, one or more second PRACH root sequences 316 distinct from the one or more first PRACH root sequences 312 and available to the first base station 105x. Determining the one or more second PRACH root sequences 316 may include selecting, based on the one or more first PRACH root sequences 312, the one or more second PRACH root sequences 316 from the group of candidate PRACH root sequences specified by the wireless communication protocol. For example, the first base station 105x may subtract the one or more first PRACH root sequences 312 from the group of candidate PRACH root sequences specified by the wireless communication protocol to determine the one or more second PRACH root sequences 316 available to the first base station 105x. In some examples, the first base station 105x determines a second cardinality of root sequences available to the first base station 105x and determines the one or more second PRACH root sequences 316 based further on the second cardinality (such as by subtracting the first cardinality from a cardinality of the group of candidate PRACH root sequences to determine the second cardinality).

To further illustrate, in some examples, the ZcZ value 366 corresponds to zero, and the PRACH root sequence index 367 corresponds to zero. In such examples, the first cardinality may correspond to 64 (where root indices 0 to 63 are in use by the second base station 105y), as shown in the fourth column of Example 2. Further, 74 root indices may be available (where root indices 64 to 137 are unused by the second base station 105y). In this case, the first base station 105x may identify that root indices 64 to 74 are available for use by the first base station 105x (because use of root indices 75 to 137 may be associated with overlap of one or more of root indices 0 to 63 in a mod(137) scheme). As a result, the second cardinality may correspond to 11 (as shown in the fifth column of Example 2), and the one or more second PRACH root sequences 316 may correspond to root indices 64 to 74.

As another example, the ZcZ value 366 may correspond to zero, and the PRACH root sequence index 367 may correspond to 137. In such examples, the first cardinality may correspond to 64 (where root indices 137 to 62 are in use by the second base station 105y), and 74 root indices may be available (where root indices 63 to 136 are unused by the second base station 105y). In this case, the first base station 105x may identify that root indices 63 to 73 are available for use by the first base station 105x (because use of root indices 74 to 136 may be associated with overlap of one or more of root indices 137 to 62 in a mod(137) scheme). As a result, the second cardinality may correspond to 11, and the one or more second PRACH root sequences 316 may correspond to root indices 63 to 73.

As an additional example, the ZcZ value 366 may correspond to one, and the PRACH root sequence index 367 may correspond to zero. In such examples, the first cardinality may correspond to 1 (where root index 0 is in use by the second base station 105y), and 137 root indices may be available (where root indices 1 to 137 are unused by the second base station 105y). In this case, the first base station 105x may identify that root indices 1 to 137 are available for use by the first base station 105x. As a result, the second cardinality may correspond to 137, and the one or more second PRACH root sequences 316 may correspond to root indices 1 to 137.

As a further example, the ZcZ value 366 may correspond to one, and the PRACH root sequence index 367 may correspond to 137. In such examples, the first cardinality may correspond to 1 (where root index 137 is in use by the second base station 105y), and 137 root indices may be available (where root indices 0 to 136 are unused by the second base station 105y). In this case, the first base station 105x may identify that root indices 0 to 136 are available for use by the first base station 105x. As a result, the second cardinality may correspond to 137, and the one or more second PRACH root sequences 316 may correspond to root indices 0 to 136.

The first base station 105x may select a PRACH root sequence 318 from the one or more second PRACH root sequences 316. In some examples, the first base station 105x selects the numerically greatest PRACH root sequence from the one or more second PRACH root sequences 316 as the PRACH root sequence 318. In some other examples, the first base station 105x selects the numerically lowest PRACH root sequence from the one or more second PRACH root sequences 316 as the PRACH root sequence 318. In some other examples, the first base station 105x may randomly or pseudo-randomly select the PRACH root sequence 318 from the one or more second PRACH root sequences 316. The first base station 105x may select the PRACH root sequence 318 such that no root generated based on (or derived from) the PRACH root sequence 318 is included in the one or more first PRACH root sequences 312. For example, in a mod(137) scheme, if the second base station 105y uses root index 0, then selection of root index 137 as the PRACH root sequence 318 may cause a next root generated based on the PRACH root sequence 318 to overlap with root index 0.

The first base station 105x may transmit a second SIB1 370 based on the PRACH root sequence 318. To illustrate, the first base station 105x may determine, based on the PRACH root sequence 318, second PRACH parameters 371 that are different than the PRACH parameters 361. For example, the second PRACH parameters 371 may include one or more of a ZcZ value that is different than the ZcZ value 366 or a PRACH root sequence index that is different than the PRACH root sequence index 367. In some examples, the second SIB1 370 has a format corresponding to the format described with reference to Example 1.

One or more UEs may receive the second SIB1 370 and may communicate with the first base station 105x based on the second PRACH parameters 371. To illustrate, the UE 115 may receive the second SIB1 370 and may transmit, to the first base station 105x, a PRACH preamble based on the second PRACH parameters 371.

Although certain examples have been described with reference to a single first SIB1 360, in some other examples, the first base station 105x may receive SIB1s from multiple base stations. To illustrate, the first base station 105x may receive one or more third SIB1s 380 from the one or more third base stations 105z. The first base station 105x may determine, based on the one or more third SIB1s, PRACH parameters associated with the one or more third base stations 105z and may determine, based on the PRACH parameters, one or more third PRACH root sequences 314 associated with the one or more third base stations 105z (such as using one or more operations described with reference to the PRACH parameters 361 an the first PRACH root sequences 312). The one or more third PRACH root sequences 314 may be distinct from the one or more first PRACH root sequences 312. The first base station 105x may determine the one or more second PRACH root sequences 316 based on the first PRACH root sequences 312 and further based on the one or more third PRACH root sequences 314.

In some circumstances, the second cardinality of the one or more second PRACH root sequences 316 may be relatively small (such as when a large number of base stations 105y-z use a relatively large number of root indices). To illustrate, prior to determining the one or more second PRACH root sequences 316, the first base station 105x may detect a failure to identify one or more available PRACH root sequences that are unused by the second base station 105y. In some such examples, based on the failure to identifying one or more available PRACH root sequences, the first base station 105x may adjust a cyclic shift (Ncs) value associated with the first base station 105x such as from a first value to a second value. The first base station 105x may adjust the Ncs value within a range of cyclic shift values 334. In some wireless communication protocols, the range of cyclic shift values 334 may be based on a cell radius of the first base station 105x. In some examples, the first base station 105x selects the Ncs value that provides the greatest number of preambles per root. After adjusting the Ncs value from the first value to the second value, the first base station 105x may determine (or re-determine) the one or more second PRACH root sequences 316 based on the second value and may select the PRACH root sequence 318 from the re-determined second PRACH root sequences 316.

In some other examples, after detecting the failure to identify one or more available PRACH root sequences that are unused by the second base station 105y, the first base station 105x may select the PRACH root sequence 318 using one or more other techniques. For example, after detecting the failure to identify one or more available PRACH root sequences that are unused by the second base station 105y, the first base station 105x may select the PRACH root sequence 318 based on a correlation of the PRACH root sequence 318 to the one or more first PRACH root sequences 312, such as based on a determination that the correlation of the PRACH root sequence 318 to the one or more first PRACH root sequences 312 is less than respective correlations of others of the one or more second PRACH root sequences 316 to the one or more first PRACH root sequences 312. As referred to herein, correlation between PRACH root sequences may indicate or may be associated with an amount of interference between the PRACH root sequences. For example, PRACH root sequences of different base stations may be correlated if transmissions based on the PRACH root sequences interfere with or are likely to interfere with one another, which may cause a false PRACH signal detection in some circumstances.

As another example, after detecting the failure to identify one or more available PRACH root sequences that are unused by the second base station 105y, the first base station 105x may select the PRACH root sequence 318 based on a comparison of an energy parameter (such as a peak energy per preamble window per PRACH root sequence) to a PRACH detection threshold. For example, the first base station 105x may select the PRACH root sequence 318 based on a determination that a peak energy per preamble window associated with the PRACH root sequence 318 satisfies (or fails to satisfy) the PRACH detection threshold. A preamble window may also be referred to as a cyclic shift window. In some examples, the PRACH detection threshold may correspond to or may be based on a cell radius associated with the first base station 105x. In some examples, the cell radius may be based on one or more of a signal-to-noise ratio (SNR) of a signal associated with the first base station 105x (which may be expressed in decibels (dB)), a signal-to-noise plus interference (SINR) associated with the signal (which may be expressed in dB), a received signal strength indicator (RSSI) associated with the signal (which may be expressed in decibel-milliwatt (dBm)), a reference signal received power (RSRP) associated with the signal (which may be expressed in dBm), or a quality metric associated with the signal (which may be expressed in dB). In some implementations, the PRACH detection threshold may be selected to enable discarding or filtering of preambles of PRACH transmissions associated with one or more neighbor base stations of the first base station 105x (such as by reducing or avoiding use of a PRACH root sequence that is associated with a relatively low peak energy per preamble window).

In some implementations, the one or more second PRACH root sequences 316 are allocated among contention free random access (CFRA) process, a contention based random access (CBRA) process, or both. In some examples, the one or more second PRACH root sequences 316 are allocated among the CFRA process and the CBRA process based on a priority scheme that specifies priority for the CFRA process over the CBRA process. In such examples, the first base station 105x may allocate the PRACH root sequence 318 to the CFRA process. After allocating the PRACH root sequence 318 to the CFRA process, the first base station 105x may allocate another PRACH root sequence of the one or more second PRACH root sequences 316 to the CBRA process. Accordingly, in some such examples, preambles of one PRACH root sequence may be allocated first to the CFRA process, and preambles of another PRACH root sequence may then be allocated to the CBRA process.

In some other examples, preambles of a common PRACH root sequence may be allocated first to the CFRA process and then to the CBRA process. For example, the first base station 105x may allocate one or more preambles associated with the PRACH root sequence 318 to the CFRA process, where the one or more preambles are not in use by the second base station 105y. After allocating the one or more preambles associated with the PRACH root sequence 318 to the CFRA process, the first base station 105x may allocate one or more remaining preambles associated with the PRACH root sequence 318 to the CBRA process, where the one or more remaining preambles are not in use by the second base station 105y. To illustrate, the first base station 105x may allocate a first preamble associated with the PRACH root sequence 318 to the CFRA process and may allocate a second preamble associated with the PRACH root sequence 318 to the CBRA process. Accordingly, in some examples, preambles associated with the PRACH root sequence 318 may be allocated first to the CFRA process and then to the CBRA process.

One or more aspects described with reference to FIG. 3 may improve performance of a wireless communication system. For example, by selecting an unused PRACH root sequence 318, the first base station 105x may reduce or avoid preamble collisions that may occur due to transmission of the same PRACH preamble based on selection of the same PRACH root sequence by the base stations 105x and 105y. Further, by associating different PRACH parameters with the base stations 105x and 105y, instances of “false detection” (where the UE 115 attempts to communicate with one base station but inadvertently connects with another base station) may be reduced or avoided.

Further, certain aspects described with reference to FIG. 3 may reduce or avoid receiver complexity associated with certain time domain operations. To illustrate, certain receivers monitor for peaks in a preamble window of a received SIB1 using a time domain estimation technique and attempt to reduce or suppress the peaks using time domain based processing techniques. Such techniques may be associated with processing delays and receiver complexity. By selecting an unused PRACH root sequence 318 as described herein, the first base station 105x may reduce or avoid such processing delays and receiver complexity.

FIG. 4 is a flow diagram illustrating an example process 400 that supports PRACH root sequence selection according to one or more aspects. Operations of the process 400 may be performed by a base station, such as the first base station 105x.

In block 402, the base station receives a first SIB1 from a second base station. For example, first base station 105x may receive the first SIB1 360 from the second base station 105y.

In block 404, the base station determines, based on the first SIB1, a plurality of PRACH parameters associated with the second base station. For example, the first base station 105x may determine the PRACH parameters 361 based on the first SIB1 360.

In block 406, the base station determines, based on the plurality of PRACH parameters, one or more first PRACH root sequences associated with the second base station. For example, the first base station 105x may determine the one or more first PRACH root sequences 312 based on the PRACH parameters 361.

In block 408, the base station determines, based on the one or more first PRACH root sequences, one or more second PRACH root sequences each different than each of the one or more first PRACH root sequences and available to the base station. For example, the first base station 105x may determine the one or more second PRACH root sequences 316 based on the one or more first PRACH root sequences 312.

In block 410, the base station selects a PRACH root sequence from the one or more second PRACH root sequences. For example, the first base station 105x may select the PRACH root sequences 318 from the one or more second PRACH root sequences 316.

In block 412, the base station transmits a second SIB1 based on the selected PRACH root sequence. For example, the first base station 105x may transmit the second SIB1 370 based on the PRACH root sequence 318.

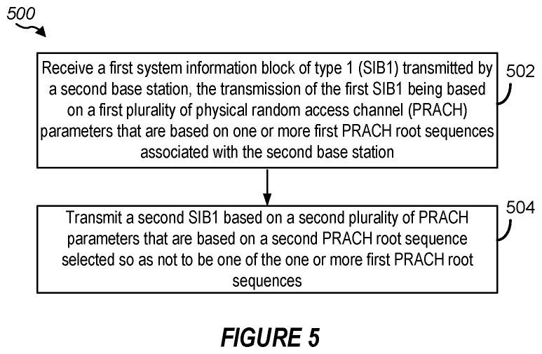

FIG. 5 is a flow diagram illustrating an example process 500 that supports PRACH root sequence selection according to one or more aspects. Operations of the process 500 may be performed by a base station, such as the first base station 105x.

In block 502, the base station receives a first SIB1 transmitted by a second base station. The transmission of the first SIB1 is based on a first plurality of PRACH parameters that are based on one or more first PRACH root sequences associated with the second base station. For example, the first base station 105x may receive the first SIB1 360 transmitted by the second base station 105y. The transmission of the first SIB1 360 by the second base station 105y may be based on the PRACH parameters 361, and the PRACH parameters 361 may be based on the one or more first PRACH root sequences 312 associated with the second base station 105y.

In block 504, the base station transmits a second SIB1 based on a second plurality of a PRACH parameters. The second plurality of PRACH parameters are based on a second PRACH root sequence selected so as not to be one of the one or more first PRACH root sequences. For example, the first base station 105x may transmit the second SIB1 370 based on the second PRACH parameters 371, and the second PRACH parameters 371 may be based on the PRACH root sequence 318. The first base station 105x may select the PRACH root sequence 318 so that the PRACH root sequence 318 is not one of the one or more first PRACH root sequences 312.

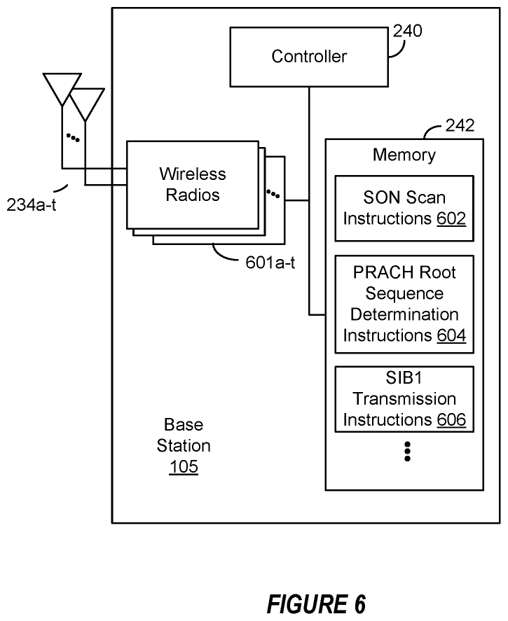

FIG. 6 is a block diagram of an example base station 105 that supports PRACH root sequence selection according to one or more aspects. The base station 105 may be configured to perform one or more operations described herein, such as one or more blocks of the process 400 described with reference to FIG. 4. In some implementations, the base station 105 includes structure, hardware, and components shown and described with reference to FIGS. 1-3. For example, the base station 105 may include the controller 240, which may execute logic or computer instructions stored in the memory 242, as well as controlling the components of the base station 105 that provide the features and functionality of the base station 105. The base station 105, under control of the controller 240, transmits and receives signals via wireless radios 601a-t and the antennas 234a-t. The wireless radios 601a-t include various components and hardware, as illustrated in FIG. 2 for the base station 105, including the modulator and demodulators 232a-t, the transmit processor 220, the TX MIMO processor 230, the MIMO detector 236, and the receive processor 238.

In some implementations, one or more hardware components illustrated in FIG. 6 are configured to initiate, perform, or control one or more operations described herein. Alternatively or in addition, the memory 242 may store processor-readable code executable by the controller 240 to initiate, perform, or control one or more operations described herein. For example, the memory 242 may store SON scan instructions 602 executable by the controller 240 to perform the SON scan 336 and to receive the first SIB1 360 based on the SON scan 336. As another example, the memory 242 may store PRACH root sequence determination instructions 604 executable by the controller 240 to determine the PRACH parameters 361 based on the first SIB1 360, determine the one or more first PRACH root sequences 312 based on the PRACH parameters 361, to determine the one or more second PRACH root sequences 316 based on the one or more first PRACH root sequences 312, and to select the PRACH root sequences 318 from the one or more second PRACH root sequences 316. As an additional example, the memory 242 may store SIB1 transmission instructions 606 executable by the controller 240 to transmit the second SIB1 370 based on the PRACH root sequence 318.

In a first aspect, a method for wireless communication performed by base station includes receiving a first system information block of type 1 (SIB1) from a second base station and determining, based on the first SIB1, a plurality of physical random access channel (PRACH) parameters associated with the second base station. The method further includes determining, based on the plurality of PRACH parameters, one or more first PRACH root sequences associated with the second base station and determining, based on the one or more first PRACH root sequences, one or more second PRACH root sequences each different than each of the one or more first PRACH root sequences and available to the base station. The method further includes selecting a PRACH root sequence from the one or more second PRACH root sequences and transmitting a second SIB1 based on the selected PRACH root sequence.

In a second aspect, alone or in combination with the first aspect, the plurality of PRACH parameters include one or more of a duplex mode indication, a PRACH configuration index, a ZcZ value, a PRACH root sequence index, or a PRACH format length indication.

In a third aspect, alone or in combination with one or more of the first aspect or second aspect, the method includes determining a frequency range associated with the first SIB1, determining, based on the duplex mode indication, a duplex mode type associated with the second base station, identifying, based on the frequency range and the duplex mode type, a PRACH configuration index table, and identifying, based on the PRACH configuration index, a preamble format in the PRACH configuration index table, where the preamble format is associated with the first SIB1.

In a fourth aspect, alone or in combination with one or more of the first aspect through third aspect, the method includes determining, based on the preamble format, a sequence length and a subcarrier spacing, determining a mapping of the ZcZ value to an NCS value based on the subcarrier spacing, and determining a cardinality of preambles per PRACH root sequence associated with the second base station based on a ratio of the sequence length to the Ncs value. Determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

In a fifth aspect, alone or in combination with one or more of the first aspect through fourth aspect, determining the one or more second PRACH root sequences includes selecting, based on the one or more first PRACH root sequences, the one or more second PRACH root sequences from the plurality of candidate PRACH root sequences specified by the wireless communication protocol.

In a sixth aspect, alone or in combination with one or more of the first aspect through fifth aspect, the method includes receiving one or more third SIB1s from one or more third base stations, determining, based on the one or more third SIB1s, PRACH parameters associated with the one or more third base stations, and determining, based on the PRACH parameters associated with the one or more third base stations, one or more third PRACH root sequences associated with the one or more third base stations. The one or more second PRACH root sequences are based further on the one or more third PRACH root sequences and each of the one or more second PRACH root sequences is different than each of the one or more third PRACH root sequences.

In a seventh aspect, alone or in combination with one or more of the first aspect through the sixth aspect, the method includes detecting, prior to determining the one or more second PRACH root sequences and based on a first value of an NCS value associated with the base station, a failure to identify one or more available PRACH root sequences that are unused by the second base station. The method further includes adjusting, based on the failure to identify the one or more available PRACH root sequences, the Ncs value associated with the base station to a second value. The first value and the second value are included in a range of cyclic shift values that is based on a cell radius associated with the base station. The method further includes determining the one or more second PRACH root sequences based on the second value of the NCS value.

In an eighth aspect, alone or in combination with one or more of the first through the seventh aspect, the method includes allocating the selected PRACH root sequence to a CFRA process and allocating, after allocating the selected PRACH root sequence to the CFRA process, another PRACH root sequence of the one or more second PRACH root sequences to a CBRA process.

In a ninth aspect, alone or in combination with one or more of the first through the eighth aspect, the method includes performing a SON scan, and the base station receives the SIB1 based on the SON scan.

In a tenth aspect, alone or in combination with one or more of the first through the ninth aspect, a base station includes at least one processor and a memory coupled with the at least one processor and storing processor-readable code that is executable by the at least one processor to receive a first SIB1 from a second base station and to determine, based on the first SIB1, a plurality of PRACH parameters associated with the second base station. The processor-readable code is further executable by the at least one processor to determine, based on the plurality of PRACH parameters, one or more first PRACH root sequences associated with the second base station and to determine, based on the one or more first PRACH root sequences, one or more second PRACH root sequences each different than each of the one or more first PRACH root sequences and available to the base station. The processor-readable code is further executable by the at least one processor to select a PRACH root sequence from the one or more second PRACH root sequences and to transmit a second SIB1 based on the selected PRACH root sequence.

In an eleventh aspect, alone or in combination with one or more of the first through the tenth aspect, the plurality of PRACH parameters include one or more of a duplex mode indication, a PRACH configuration index, a ZcZ value, a PRACH root sequence index, or a PRACH format length indication.

In a twelfth aspect, alone or in combination with one or more of the first through the eleventh aspect, the processor-readable code is further executable by the at least one processor to determine a frequency range associated with the first SIB1, to determine, based on the duplex mode indication, a duplex mode type associated with the second base station, to identify, based on the frequency range and the duplex mode type, a PRACH configuration index table, and to identify, based on the PRACH configuration index, a preamble format in the PRACH configuration index table, where the preamble format is associated with the first SIB1.

In a thirteenth aspect, alone or in combination with one or more of the first through the twelfth aspect, the processor-readable code is further executable by the at least one processor to determine, based on the preamble format, a sequence length and a sub carrier spacing, to determine a mapping of the ZcZ value to an NCS value based on the subcarrier spacing, and to determine a cardinality of preambles per PRACH root sequence associated with the second base station based on a ratio of the sequence length to the Ncs value. Determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

In a fourteenth aspect, alone or in combination with one or more of the first through the thirteenth aspect, the processor-readable code is further executable by the at least one processor to select, based on the one or more first PRACH root sequences, the one or more second PRACH root sequences from the plurality of candidate PRACH root sequences specified by the wireless communication protocol.

In a fifteenth aspect, alone or in combination with one or more of the first through the fourteenth aspect, the processor-readable code is further executable by the at least one processor to receive one or more third SIB1s from one or more third base stations, to determine, based on the one or more third SIB1s, PRACH parameters associated with the one or more third base stations, and to determine, based on the PRACH parameters associated with the one or more third base stations, one or more third PRACH root sequences associated with the one or more third base stations. The one or more second PRACH root sequences are based further on the one or more third PRACH root sequences and each of the one or more second PRACH root sequences is different than each of the one or more third PRACH root sequences.

In a sixteenth aspect, alone or in combination with one or more of the first through the fifteenth aspect, the processor-readable code is further executable by the at least one processor to detect, prior to determining the one or more second PRACH root sequences and based on a first value of an NCS value associated with the base station, a failure to identify one or more available PRACH root sequences that are unused by the second base station. The processor-readable code is further executable by the at least one processor to adjust, based on the failure to identify the one or more available PRACH root sequences, the Ncs value associated with the base station to a second value. The first value and the second value are included in a range of cyclic shift values that is based on a cell radius associated with the base station. The processor-readable code is further executable by the at least one processor to determine the one or more second PRACH root sequences based on the second value of the NCS value.

In a seventeenth aspect, alone or in combination with one or more of the first through the sixteenth aspect, the processor-readable code is further executable by the at least one processor to allocate the selected PRACH root sequence to a CFRA process and to allocate, after allocating the selected PRACH root sequence to the CFRA process, another PRACH root sequence of the one or more second PRACH root sequences to a CBRA process.

In an eighteenth aspect, alone or in combination with the first through the seventeenth aspect, the processor-readable code is further executable by the at least one processor to perform a SON scan, where the base station receives the SIB1 based on the SON scan.

In a nineteenth aspect, alone or in combination with one or more of the first through the eighteenth aspect, the base station includes a receiver configured to receive the first SIB1.

In a twentieth aspect, alone or in combination with one or more of the first aspect through the nineteenth aspect, the base station includes a transmitter configured to transmit the second SIB1.

In a twenty-first aspect, alone or in combination with one or more of the first aspect through the twentieth aspect, the base station corresponds to a small cell base station, and the second base station corresponds to a macro base station.

In a twenty-second aspect, alone or in combination with one or more of the first aspect through the twenty-first aspect, a base station configured for wireless communication includes means for receiving a first SIB1 from a second base station and means for determining, based on the first SIB1, a plurality of PRACH parameters associated with the second base station. The base station further includes means for determining, based on the plurality of PRACH parameters, one or more first PRACH root sequences associated with the second base station and means for determining, based on the one or more first PRACH root sequences, one or more second PRACH root sequences each different than each of the one or more first PRACH root sequences and available to the base station. The base station further includes means for selecting a PRACH root sequence from the one or more second PRACH root sequences and means for transmitting a second SIB1 based on the selected PRACH root sequence.

In a twenty-third aspect, alone or in combination with one or more of the first aspect through the twenty-second aspect, the plurality of PRACH parameters include one or more of a duplex mode indication, a PRACH configuration index, a ZcZ value, a PRACH root sequence index, or a PRACH format length indication.

In a twenty-fourth aspect, alone or in combination with one or more of the first aspect through the twenty-third aspect, the base station includes means for determining a frequency range associated with the first SIB1, means for determining, based on the duplex mode indication, a duplex mode type associated with the second base station, means for identifying, based on the frequency range and the duplex mode type, a PRACH configuration index table, and means for identifying, based on the PRACH configuration index, a preamble format in the PRACH configuration index table. The preamble format is associated with the first SIB1.

In a twenty-fifth aspect, alone or in combination with one or more of the first aspect through the twenty-fourth aspect, the base station includes means for determining, based on the preamble format, a sequence length and a subcarrier spacing, means for determining a mapping of the ZcZ value to an NCS value based on the subcarrier spacing, and means for determining a cardinality of preambles per PRACH root sequence associated with the second base station based on a ratio of the sequence length to the Ncs value. Determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

In a twenty-sixth aspect, alone or in combination with one or more of the first aspect through the twenty-fifth aspect, determining the one or more second PRACH root sequences includes selecting, based on the one or more first PRACH root sequences, the one or more second PRACH root sequences from the plurality of candidate PRACH root sequences specified by the wireless communication protocol.

In a twenty-seventh aspect, alone or in combination with one or more of the first aspect through the twenty-sixth aspect, the base station includes means for receiving one or more third SIB1s from one or more third base stations, means for determining, based on the one or more third SIB1s, PRACH parameters associated with the one or more third base stations, and means for determining, based on the PRACH parameters associated with the one or more third base stations, one or more third PRACH root sequences associated with the one or more third base stations. The one or more second PRACH root sequences are based further on the one or more third PRACH root sequences and each of the one or more second PRACH root sequences is different than each of the one or more third PRACH root sequences.

In a twenty-eighth aspect, alone or in combination with one or more of the first aspect through the twenty-seventh aspect, the base station includes means for detecting, prior to determining the one or more second PRACH root sequences and based on a first value of an NCS value associated with the base station, a failure to identify one or more available PRACH root sequences that are unused by the second base station. The base station further includes means for adjusting, based on the failure to identify the one or more available PRACH root sequences, the Ncs value associated with the base station to a second value. The first value and the second value are included in a range of cyclic shift values that is based on a cell radius associated with the base station. The base station further includes means for determining the one or more second PRACH root sequences based on the second value of the NCS value.

In a twenty-ninth aspect, alone or in combination with one or more of the first aspect through the twenty-eighth aspect, the base station includes means for allocating the selected PRACH root sequence to a CFRA process and means for allocating, after allocating the selected PRACH root sequence to the CFRA process, another PRACH root sequence of the one or more second PRACH root sequences to a CBRA process.

In a thirtieth aspect, alone or in combination with one or more of the first aspect through the twenty-ninth aspect, the base station includes means for performing a SON scan, where the base station receives the SIB1 based on the SON scan.

In a thirty-first aspect, alone or in combination with one or more of the first through thirtieth aspects, a method for wireless communication performed by a base station. The method includes receiving a first SIB1 transmitted by a second base station. The transmission of the first SIB1 is based on a first plurality of PRACH parameters that are based on one or more first PRACH root sequences associated with the second base station. The method further includes transmitting a second SIB1 based on a second plurality of PRACH parameters. The second plurality of PRACH parameters are based on a second PRACH root sequence selected so as not to be one of the one or more first PRACH root sequences.

In a thirty-second aspect, alone or in combination with one or more of the first through thirty-first aspects, the first plurality of PRACH parameters include one or more of a duplex mode indication, a PRACH configuration index, a ZcZ value, a PRACH root sequence index, or a PRACH format length indication.

In a thirty-third aspect, alone or in combination with one or more of the first through thirty-second aspects, the method includes: determining a frequency range associated with the first SIB1; determining, based on the duplex mode indication, a duplex mode type associated with the second base station; identifying, based on the frequency range and the duplex mode type, a PRACH configuration index table; and identifying, based on the PRACH configuration index, a preamble format in the PRACH configuration index table, where the preamble format is associated with the first SIB1.

In a thirty-fourth aspect, alone or in combination with one or more of the first through thirty-third aspects, the method includes: determining, based on the preamble format, a sequence length and a subcarrier spacing; determining a mapping of the ZcZ value to an Ncs value based on the subcarrier spacing; and determining a cardinality of preambles per PRACH root sequence associated with the second base station based on a ratio of the sequence length to the Ncs value, where determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

In a thirty-fifth aspect, alone or in combination with one or more of the first through thirty-fourth aspects, determining the one or more second PRACH root sequences includes selecting, based on the one or more first PRACH root sequences, the one or more second PRACH root sequences from the plurality of candidate PRACH root sequences specified by the wireless communication protocol.

In a thirty-sixth aspect, alone or in combination with one or more of the first through thirty-fifth aspects, the method includes: receiving one or more third SIB1s from one or more third base stations; determining, based on the one or more third SIB1s, PRACH parameters associated with the one or more third base stations; and determining, based on the PRACH parameters associated with the one or more third base stations, one or more third PRACH root sequences associated with the one or more third base stations, where the one or more second PRACH root sequences are based further on the one or more third PRACH root sequences and each of the one or more second PRACH root sequences is different than each of the one or more third PRACH root sequences.

In a thirty-seventh aspect, alone or in combination with one or more of the first through thirty-sixth aspects, the method includes: detecting, prior to determining the one or more second PRACH root sequences and based on a first value of an Ncs value associated with the base station, a failure to identify one or more available PRACH root sequences that are unused by the second base station; adjusting, based on the failure to identify the one or more available PRACH root sequences, the Ncs value associated with the base station to a second value, where the first value and the second value are included in a range of cyclic shift values that is based on a cell radius associated with the base station; and determining the one or more second PRACH root sequences based on the second value of the NCS value.

In a thirty-eighth aspect, alone or in combination with one or more of the first through thirty-seventh aspects, the method includes: detecting, prior to determining the one or more second PRACH root sequences, a failure to identify one or more available PRACH root sequences that are unused by the second base station, where the second PRACH root sequence is selected based on the failure to identify the one or more available PRACH root sequences and further based on a correlation of the second PRACH root sequence to the one or more first PRACH root sequences.

In a thirty-ninth aspect, alone or in combination with one or more of the first through thirty-eighth aspects, the method includes: detecting, prior to determining the one or more second PRACH root sequences, a failure to identify one or more available PRACH root sequences that are unused by the second base station, where the second PRACH root sequence is selected based on the failure to identify the one or more available PRACH root sequences and further based on a comparison of a peak energy per preamble window per PRACH root sequence to a PRACH detection threshold.

In a fortieth aspect, alone or in combination with one or more of the first through thirty-ninth aspects, the PRACH detection threshold is based on a cell radius associated with the base station, and the cell radius is based on one or more of an SNR of a signal associated with the base station, an SINR associated with the signal, an RSSI associated with the signal, an RSRP associated with the signal, or a quality metric associated with the signal.

In a forty-first aspect, alone or in combination with one or more of the first through fortieth aspects, the method includes: allocating the second PRACH root sequence to a CFRA process; and allocating, after allocating the second PRACH root sequence to the CFRA process, another PRACH root sequence of the one or more second PRACH root sequences to a CBRA process.

In a forty-second aspect, alone or in combination with one or more of the first through forty-first aspects, the method includes: allocating one or more preambles associated with the second PRACH root sequence to a CFRA process, where the one or more preambles are not in use by the second base station; and allocating, after allocating the one or more preambles associated with the second PRACH root sequence to the CFRA process, one or more remaining preambles associated with the second PRACH root sequence to a CBRA process, where the one or more remaining preambles are not in use by the second base station.

In a forty-third aspect, alone or in combination with one or more of the first through forty-second aspects, the method includes performing an SON scan, where the base station receives the SIB1 based on the SON scan.

In a forty-fourth aspect, alone or in combination with one or more of the first through forty-third aspects, a base station that includes at least one processor and a memory coupled with the at least one processor. The memory stores processor-readable code executable by the at least one processor to receive a first SIB1 transmitted by a second base station. The transmission of the first SIB1 is based on a first plurality of PRACH parameters that are based on one or more first PRACH root sequences associated with the second base station. The processor-readable code is further executable by the at least one processor to transmit a second SIB1 based on a second plurality of PRACH parameters. The second plurality of PRACH parameters are based on a second PRACH root sequence selected so as not to be one of the one or more first PRACH root sequences.

In a forty-fifth aspect, alone or in combination with one or more of the first through forty-fifth aspects, the first plurality of PRACH parameters include one or more of a duplex mode indication, a PRACH configuration index, a ZcZ value, a PRACH root sequence index, or a PRACH format length indication.

In a forty-sixth aspect, alone or in combination with one or more of the first through forty-fifth aspects, the processor-readable code is further executable by the at least one processor to: determine a frequency range associated with the first SIB1; determine, based on the duplex mode indication, a duplex mode type associated with the second base station; identify, based on the frequency range and the duplex mode type, a PRACH configuration index table; and identify, based on the PRACH configuration index, a preamble format in the PRACH configuration index table, where the preamble format is associated with the first SIB1.

In a forty-seventh aspect, alone or in combination with one or more of the first through forty-sixth aspects, the processor-readable code is further executable by the at least one processor to: determine, based on the preamble format, a sequence length and a subcarrier spacing; determine a mapping of the ZcZ value to an Ncs value based on the subcarrier spacing; and determine a cardinality of preambles per PRACH root sequence associated with the second base station based on a ratio of the sequence length to the Ncs value, where determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

In a forty-eighth aspect, alone or in combination with one or more of the first through forty-seventh aspects, the processor-readable code is further executable by the at least one processor to select, based on the one or more first PRACH root sequences, the one or more second PRACH root sequences from the plurality of candidate PRACH root sequences specified by the wireless communication protocol.

In a forty-ninth aspect, alone or in combination with one or more of the first through forty-eighth aspects, the processor-readable code is further executable by the at least one processor to: receive one or more third SIB1s from one or more third base stations; determine, based on the one or more third SIB1s, PRACH parameters associated with the one or more third base stations; and determine, based on the PRACH parameters associated with the one or more third base stations, one or more third PRACH root sequences associated with the one or more third base stations, where the one or more second PRACH root sequences are based further on the one or more third PRACH root sequences and each of the one or more second PRACH root sequences is different than each of the one or more third PRACH root sequences.

In a fiftieth aspect, alone or in combination with one or more of the first through forty-ninth aspects, the processor-readable code is further executable by the at least one processor to: detect, prior to determining the one or more second PRACH root sequences and based on a first value of an Ncs value associated with the base station, a failure to identify one or more available PRACH root sequences that are unused by the second base station; adjust, based on the failure to identify the one or more available PRACH root sequences, the Ncs value associated with the base station to a second value, where the first value and the second value are included in a range of cyclic shift values that is based on a cell radius associated with the base station; and determine the one or more second PRACH root sequences based on the second value of the NCS value.

In a fifty-first aspect, alone or in combination with one or more of the first through fiftieth aspects, the processor-readable code is further executable by the at least one processor to: detect, prior to determining the one or more second PRACH root sequences, a failure to identify one or more available PRACH root sequences that are unused by the second base station; and select the second PRACH root sequence based on the failure to identify the one or more available PRACH root sequences and further based on a correlation of the second PRACH root sequence to the one or more first PRACH root sequences.

In a fifty-second aspect, alone or in combination with one or more of the first through fifty-first aspects, the processor-readable code is further executable by the at least one processor to: detect, prior to determining the one or more second PRACH root sequences, a failure to identify one or more available PRACH root sequences that are unused by the second base station; and select the second PRACH root sequence based on the failure to identify the one or more available PRACH root sequences and further based on a comparison of a peak energy per preamble window per PRACH root sequence to a PRACH detection threshold.

In a fifty-third aspect, alone or in combination with one or more of the first through fifty-second aspects, the PRACH detection threshold is based on a cell radius associated with the base station, and the cell radius is based on one or more of an SNR of a signal associated with the base station, an SINR associated with the signal, an RSSI associated with the signal, an RSRP associated with the signal, or a quality metric associated with the signal.

In a fifty-fourth aspect, alone or in combination with one or more of the first through fifty-third aspects, the processor-readable code is further executable by the at least one processor to: allocate the second PRACH root sequence to a CFRA process; and allocate, after allocating the second PRACH root sequence to the CFRA process, another PRACH root sequence of the one or more second PRACH root sequences to a CBRA process.

In a fifty-fifth aspect, alone or in combination with one or more of the first through fifty-fourth aspects, the processor-readable code is further executable by the at least one processor to: allocate one or more preambles associated with the second PRACH root sequence to a CFRA process, where the one or more preambles are not in use by the second base station; and allocate, after allocating the one or more preambles associated with the second PRACH root sequence to the CFRA process, one or more remaining preambles associated with the second PRACH root sequence to a CBRA process, where the one or more remaining preambles are not in use by the second base station.

In a fifty-sixth aspect, alone or in combination with one or more of the first through fifty-fifth aspects, the processor-readable code is further executable by the at least one processor to perform an SON scan, where the base station receives the SIB1 based on the SON scan.

In a fifty-seventh aspect, alone or in combination with one or more of the first through fifty-sixth aspects, the base station is a small cell base station, and the second base station is a macro base station.

In a fifty-eighth aspect, alone or in combination with one or more of the first through fifty-seventh aspects, a base station includes means for receiving a first SIB1 transmitted by a second base station. The transmission of the first SIB1 is based on a first plurality of PRACH parameters that are based on one or more first PRACH root sequences associated with the second base station. The apparatus further includes means for transmitting a second SIB1 based on a second plurality of PRACH parameters. The second plurality of PRACH parameters are based on a second PRACH root sequence selected so as not to be one of the one or more first PRACH root sequences.

In a fifty-ninth aspect, alone or in combination with one or more of the first through fifty-eighth aspects, the base station includes: means for allocating the second PRACH root sequence to a CFRA process; and means for allocating, after allocating the second PRACH root sequence to the CFRA process, another PRACH root sequence of the one or more second PRACH root sequences to a CBRA process.

In a sixtieth aspect, alone or in combination with one or more of the first through fifty-ninth aspects, the base station includes: means for allocating one or more preambles associated with the second PRACH root sequence to a CFRA process, where the one or more preambles are not in use by the second base station; and means for allocating, after allocating the one or more preambles associated with the second PRACH root sequence to the CFRA process, one or more remaining preambles associated with the second PRACH root sequence to a CBRA process, where the one or more remaining preambles are not in use by the second base station.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and operations described herein may be implemented as electronic hardware, computer software, or combinations of both. To illustrate, various illustrative components, blocks, modules, circuits, and operations have been described above generally in terms of their functionality. Whether such functionality is implemented as hardware or software depends upon the particular application and the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The operations of a method or process disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or process may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication performed by a base station, the method comprising:
receiving a first system information block of type 1 (SIB1) transmitted by a second base station, the transmission of the first SIB1 being based on a first plurality of physical random access channel (PRACH) parameters that are based on one or more first PRACH root sequences associated with the second base station; and
transmitting a second SIB1 based on a second plurality of PRACH parameters that are based on a second PRACH root sequence selected so as not to be one of the one or more first PRACH root sequences.

2. The method of claim 1, wherein the first plurality of PRACH parameters include one or more of a duplex mode indication, a PRACH configuration index, a zero correlation zone (ZcZ) value, a PRACH root sequence index, or a PRACH format length indication.

3. The method of claim 2, further comprising:
determining a frequency range associated with the first SIB1;
determining, based on the duplex mode indication, a duplex mode type associated with the second base station;
identifying, based on the frequency range and the duplex mode type, a PRACH configuration index table; and
identifying, based on the PRACH configuration index, a preamble format in the PRACH configuration index table, wherein the preamble format is associated with the first SIB1.

4. The method of claim 3, further comprising:
determining, based on the preamble format, a sequence length and a subcarrier spacing;
determining a mapping of the ZcZ value to a cyclic shift (Ncs) value based on the subcarrier spacing; and
determining a cardinality of preambles per PRACH root sequence associated with the second base station based on a ratio of the sequence length to the Ncs value, wherein determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

5. The method of claim 4, wherein determining the one or more second PRACH root sequences includes selecting, based on the one or more first PRACH root sequences, the one or more second PRACH root sequences from the plurality of candidate PRACH root sequences specified by the wireless communication protocol.

6. The method of claim 1, further comprising:
receiving one or more third SIB1s from one or more third base stations;
determining, based on the one or more third SIB1s, PRACH parameters associated with the one or more third base stations; and
determining, based on the PRACH parameters associated with the one or more third base stations, one or more third PRACH root sequences associated with the one or more third base stations,
wherein the one or more second PRACH root sequences are based further on the one or more third PRACH root sequences and each of the one or more second PRACH root sequences is different than each of the one or more third PRACH root sequences.

7. The method of claim 1, further comprising:
detecting, prior to determining the one or more second PRACH root sequences and based on a first value of a cyclic shift (Ncs) value associated with the base station, a failure to identify one or more available PRACH root sequences that are unused by the second base station;
adjusting, based on the failure to identify the one or more available PRACH root sequences, the Ncs value associated with the base station to a second value, wherein the first value and the second value are included in a range of cyclic shift values that is based on a cell radius associated with the base station; and
determining the one or more second PRACH root sequences based on the second value of the NCS value.

8. The method of claim 1, further comprising:
detecting, prior to determining the one or more second PRACH root sequences, a failure to identify one or more available PRACH root sequences that are unused by the second base station, wherein the second PRACH root sequence is selected based on the failure to identify the one or more available PRACH root sequences and further based on a correlation of the second PRACH root sequence to the one or more first PRACH root sequences.

9. The method of claim 1, further comprising:
detecting, prior to determining the one or more second PRACH root sequences, a failure to identify one or more available PRACH root sequences that are unused by the second base station, wherein the second PRACH root sequence is selected based on the failure to identify the one or more available PRACH root sequences and further based on a comparison of a peak energy per preamble window per PRACH root sequence to a PRACH detection threshold.

10. The method of claim 9, wherein the PRACH detection threshold is based on a cell radius associated with the base station, and wherein the cell radius is based on one or more of a signal-to-noise ratio (SNR) of a signal associated with the base station, a signal-to-noise plus interference (SINR) associated with the signal, a received signal strength indicator (RSSI) associated with the signal, a reference signal received power (RSRP) associated with the signal, or a quality metric associated with the signal.

11. The method of claim 1, further comprising:
allocating the second PRACH root sequence to a contention free random access (CFRA) process; and
allocating, after allocating the second PRACH root sequence to the CFRA process, another PRACH root sequence of the one or more second PRACH root sequences to a contention based random access (CBRA) process.

12. The method of claim 1, further comprising:
allocating one or more preambles associated with the second PRACH root sequence to a contention free random access (CFRA) process, wherein the one or more preambles are not in use by the second base station; and
allocating, after allocating the one or more preambles associated with the second PRACH root sequence to the CFRA process, one or more remaining preambles associated with the second PRACH root sequence to a contention based random access (CBRA) process, wherein the one or more remaining preambles are not in use by the second base station.

13. The method of claim 1, further comprising performing a self-organizing network (SON) scan, wherein the base station receives the SIB1 based on the SON scan.

14. A base station comprising:
at least one processor; and
a memory coupled with the at least one processor and storing processor-readable code executable by the at least one processor to:
receive a first system information block of type 1 (SIB1) transmitted by a second base station, the transmission of the first SIB1 being based on a first plurality of physical random access channel (PRACH) parameters that are based on one or more first PRACH root sequences associated with the second base station; and
transmit a second SIB1 based on a second plurality of PRACH parameters that are based on a second PRACH root sequence selected so as not to be one of the one or more first PRACH root sequences.

15. The base station of claim 14, wherein the first plurality of PRACH parameters include one or more of a duplex mode indication, a PRACH configuration index, a zero correlation zone (ZcZ) value, a PRACH root sequence index, or a PRACH format length indication.

16. The base station of claim 15, wherein the processor-readable code is further executable by the at least one processor to:
determine a frequency range associated with the first SIB1;
determine, based on the duplex mode indication, a duplex mode type associated with the second base station;
identify, based on the frequency range and the duplex mode type, a PRACH configuration index table; and
identify, based on the PRACH configuration index, a preamble format in the PRACH configuration index table, wherein the preamble format is associated with the first SIB1.

17. The base station of claim 16, wherein the processor-readable code is further executable by the at least one processor to:
determine, based on the preamble format, a sequence length and a subcarrier spacing;
determine a mapping of the ZcZ value to a cyclic shift (Ncs) value based on the subcarrier spacing; and
determine a cardinality of preambles per PRACH root sequence associated with the second base station based on a ratio of the sequence length to the Ncs value, wherein determining the one or more first PRACH root sequences includes selecting, based on the PRACH root sequence index and based further on the cardinality of PRACH root sequences, the one or more first PRACH root sequences from a plurality of candidate PRACH root sequences specified by a wireless communication protocol.

18. The base station of claim 17, wherein the processor-readable code is further executable by the at least one processor to select, based on the one or more first PRACH root sequences, the one or more second PRACH root sequences from the plurality of candidate PRACH root sequences specified by the wireless communication protocol.

19. The base station of claim 18, wherein the processor-readable code is further executable by the at least one processor to:
receive one or more third SIB1s from one or more third base stations;
determine, based on the one or more third SIB1s, PRACH parameters associated with the one or more third base stations; and
determine, based on the PRACH parameters associated with the one or more third base stations, one or more third PRACH root sequences associated with the one or more third base stations,
wherein the one or more second PRACH root sequences are based further on the one or more third PRACH root sequences and each of the one or more second PRACH root sequences is different than each of the one or more third PRACH root sequences.

20. The base station of claim 14, wherein the processor-readable code is further executable by the at least one processor to:
detect, prior to determining the one or more second PRACH root sequences and based on a first value of a cyclic shift (Ncs) value associated with the base station, a failure to identify one or more available PRACH root sequences that are unused by the second base station;
adjust, based on the failure to identify the one or more available PRACH root sequences, the Ncs value associated with the base station to a second value, wherein the first value and the second value are included in a range of cyclic shift values that is based on a cell radius associated with the base station; and
determine the one or more second PRACH root sequences based on the second value of the NCS value.

21. The base station of claim 14, wherein the processor-readable code is further executable by the at least one processor to:
detect, prior to determining the one or more second PRACH root sequences, a failure to identify one or more available PRACH root sequences that are unused by the second base station; and
select the second PRACH root sequence based on the failure to identify the one or more available PRACH root sequences and further based on a correlation of the second PRACH root sequence to the one or more first PRACH root sequences.

22. The base station of claim 14, wherein the processor-readable code is further executable by the at least one processor to:
detect, prior to determining the one or more second PRACH root sequences, a failure to identify one or more available PRACH root sequences that are unused by the second base station; and
select the second PRACH root sequence based on the failure to identify the one or more available PRACH root sequences and further based on a comparison of a peak energy per preamble window per PRACH root sequence to a PRACH detection threshold.

23. The base station of claim 22, wherein the PRACH detection threshold is based on a cell radius associated with the base station, and wherein the cell radius is based on one or more of a signal-to-noise ratio (SNR) of a signal associated with the base station, a signal-to-noise plus interference (SINR) associated with the signal, a received signal strength indicator (RSSI) associated with the signal, a reference signal received power (RSRP) associated with the signal, or a quality metric associated with the signal.

24. The base station of claim 14, wherein the processor-readable code is further executable by the at least one processor to:
allocate the second PRACH root sequence to a contention free random access (CFRA) process; and
allocate, after allocating the second PRACH root sequence to the CFRA process, another PRACH root sequence of the one or more second PRACH root sequences to a contention based random access (CBRA) process.

25. The base station of claim 14, wherein the processor-readable code is further executable by the at least one processor to:
allocate one or more preambles associated with the second PRACH root sequence to a contention free random access (CFRA) process, wherein the one or more preambles are not in use by the second base station; and
allocate, after allocating the one or more preambles associated with the second PRACH root sequence to the CFRA process, one or more remaining preambles associated with the second PRACH root sequence to a contention based random access (CBRA) process, wherein the one or more remaining preambles are not in use by the second base station.

26. The base station of claim 14, wherein the processor-readable code is further executable by the at least one processor to perform a self-organizing network (SON) scan, wherein the base station receives the SIB1 based on the SON scan.

27. The base station of claim 14, wherein the base station is a small cell base station, and wherein the second base station is a macro base station.

28. A base station for wireless communication, the base station comprising:
means for receiving a first system information block of type 1 (SIB1) transmitted by a second base station, the transmission of the first SIB1 being based on a first plurality of physical random access channel (PRACH) parameters that are based on one or more first PRACH root sequences associated with the second base station; and
means for transmitting a second SIB1 based on a second plurality of PRACH parameters that are based on a second PRACH root sequence selected so as not to be one of the one or more first PRACH root sequences.

29. The base station of claim 28, further comprising:
means for allocating the second PRACH root sequence to a contention free random access (CFRA) process; and
means for allocating, after allocating the second PRACH root sequence to the CFRA process, another PRACH root sequence of the one or more second PRACH root sequences to a contention based random access (CBRA) process.

30. The base station of claim 28, further comprising:
means for allocating one or more preambles associated with the second PRACH root sequence to a contention free random access (CFRA) process, wherein the one or more preambles are not in use by the second base station; and
means for allocating, after allocating the one or more preambles associated with the second PRACH root sequence to the CFRA process, one or more remaining preambles associated with the second PRACH root sequence to a contention based random access (CBRA) process, wherein the one or more remaining preambles are not in use by the second base station.
